(19) United States
(12) Patent Application Publication
(10) Pub. No.: US 2008/0073951 A1
(43) Pub. Date: Mar. 27, 2008

(54) HEADREST MOVING DEVICE FOR VEHICLE

(75) Inventors: Takemi Hattori, Anjo-shi (JP); Masatoshi Mori, Anjo-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/851,140

(22) Filed: Sep. 6, 2007

(30) Foreign Application Priority Data
Sep. 21, 2006 (JP) 2006-256170

(51) Int. Cl. B60N 2/427

(52) U.S. Cl. 297/216.12

(57) ABSTRACT

A headrest moving device for a vehicle includes a headrest supporting frame adapted to be supported by a seatback frame and support a headrest so as to move forward, a fluid operated member disposed at an upper portion of the seatback frame and a fluid bag provided at an intermediate portion or at a lower portion of the seatback frame. The fluid bag communicates with the fluid operated member through a tube.

### CROSS REFERENCE TO RELATED APPLICATIONS

This application is based on and claims priority under 35 U.S.C §119 with respect to Japanese Patent Application 2006-256170, filed on Sep. 21, 2006, the entire content of which is incorporated herein by reference.

### FIELD OF THE INVENTION

This invention relates to a headrest moving device for a vehicle moving a movable headrest.

### BACKGROUND

In order to improve safety of occupants against a rear-end vehicle collision in a headrest moving device for a vehicle, various headrest moving devices have been proposed. From among those devices, the typical one moves the headrest forward based on an impact or the like to support a head of the occupant from behind.

For example, in a headrest moving device for a vehicle disclosed in JP 2005-324658A, a fluid bag and a headrest fluid bag are provided at the inside of a seat back and a headrest, respectively. The fluid bag is in communication with and contacts with the headrest fluid bag via a lower end portion of a headrest stay which comprises a hollow structure. In this case, the upper body of the occupant is moved rearward at the time of the rear-end vehicle collision, and the fluid bag, which is disposed at the seatback, is compressed. Thus, an internal pressure of the fluid bag reaches a predetermined value or more, and then the internal fluid of the fluid bag flows into the headrest fluid bag. Accordingly, the headrest fluid bag inflates and moves forward so that a surface of the headrest approaches the head of the occupant to support the head from behind.

Also, in a headrest moving device for a vehicle disclosed in JP 2004-50924A, an actuator unit is mounted to an upper frame portion which extends in a horizontal direction of an upper portion of a seatback. The actuator unit generates a driving force transmitting along the upper frame portion. In this case, if an impact exceeding a predetermined value is detected by a rear-end vehicle collision detecting sensor, the actuator unit generates the driving force based on the detection and the driving force is transmitted to a cam member. Then, the cam member presses a headrest supporting frame to pivot. Thus, the headrest supported by the headrest supporting frame moves forward and approaches the head of the occupant to support the head from behind.

Further, in a headrest moving device for a vehicle in JP 2002-274240A, a headrest supporting frame for supporting the headrest is pivotably supported by a seatback frame at an intermediate portion of the headrest supporting frame, and a pressure receiving member is provided at a lower end portion of the headrest supporting frame to receive the rearward movement of the occupant. In this case, when the upper body of the occupant is moved rearward at the time of the rear-end vehicle collision, the pressure receiving member is pressed rearward and the headrest supporting frame pivots rearward about the pivotal axis. Thus, the headrest moves forward to approach the bead of the occupant and supports the head from behind. Further, it is proposed that a ratchet mechanism is provided at the headrest moving device for a vehicle to prevent the return pivotal movement of the headrest supporting frame after the headrest is operated.

In the headrest moving device for a vehicle disclosed in JP 2005-324658A, it is presumed that connection between the headrest stay and the fluid bag of the seatback is not easily established. Because a seat provided with the headrest moving device, to which a headrest is mounted, is not easily placed in the vehicle through an opening of the vehicle door, and therefore first, the seat provided with the headrest moving device for a vehicle excluding the headrest is mounted to the vehicle and then the headrest is inserted thereto at the vehicle assembly process. Namely, the connection between the headrest stay and the fluid bag of the seatback is not easily established under the above-described assembly condition. However, despite the difficulty, a specific measure is not described in JP 2005-324658A. Also, the seat provided with the headrest moving device is configured to inflate the headrest itself by the fluid flowing into the headrest fluid bag, and thus it is presumed that the configuration requires an expensive surface leather processing.

In the seat for the vehicle disclosed in JP 2004-50924A, the rear-end vehicle collision detecting sensor is provided and the driving force is generated by the actuator unit based on the detection signals of the sensor for operating the headrest. Thus, the system becomes complicated and the cost increases.

Additionally, the actuator unit should be mounted at a limited space located in the vicinity of the upper frame portion and should generate the sufficient amount of the driving force instantaneously. Considering the current technology, cartridge actuator units are most likely to be employed to satisfy the above conditions. In this case, the actuator unit (ignition portion) must be exchanged every time the headrest is operated. For example, even if the headrest is operated by a mild rear-end vehicle collision, the actuator unit must be exchanged and this increases the cost to the user. Meanwhile, the frequency of the headrest operation may be decreased by lowering the sensitivity of the headrest operation. However, this is not practical because whiplash injuries could be caused by the mild rear-end vehicle collision.

in the headrest moving device for a vehicle disclosed in JP 2002-274240A, the simple mechanism, which pivots the headrest supporting frame about the pivotal axis, is employed. Thus, the headrest is easily moved even when the rear-end vehicle collision does not occur. For example, the headrest may be moved by a sudden acceleration of the vehicle, or an action of the occupant knee, and these unwanted operations could be annoying. Also, in order to avoid the unwanted operations of the headrest, the configuration in which the pressure receiving member is located far from the occupant, becomes mainstream of seats for vehicles. In this case, the response speed of the headrest declines at the time of the actual rear-end vehicle collision and the effectiveness of the whiplash injury prevention may be hurt. Further, the ratchet mechanism, which is for preventing the return pivotal movement, is provided with an operating lever for releasing the restriction on the pivotal movement. Thus, an extended portion of the operation lever damages the appearance of the seat provided with the headrest moving device for the vehicle.

A need exists for a headrest moving device for a vehicle which is not susceptible to the drawback mentioned above.

### SUMMARY OF THE INVENTION

According to an aspect of the present invention, a headrest moving device for a vehicle includes a headrest supporting fame adapted to be supported by a seatback frame and support a headrest so as to move forward, a fluid operated member disposed at an upper portion of the seatback frame and a fluid bag provided at an intermediate portion or at a lower portion of the seatback frame. The fluid bag communicates with the fluid operated member through a tube.

### BRIEF DESCRIPTION OF THE DRAWINGS

The foregoing and additional features and characteristics of the present invention will become more apparent from the following detailed description considered with reference to the accompanying drawings, wherein:

FIG. 1 is a perspective view illustrating a first embodiment of the present invention;

FIGS. 2A and 2B are side views illustrating the first embodiment;

FIG. 3 is a perspective view illustrating a second embodiment of the present invention;

FIGS. 4A and 4B are side views illustrating the operation of the second embodiment;

FIG. 5 is a perspective view illustrating a third embodiment of the present invention;

FIG. 6 is a cross section illustrating the third embodiment of the embodiment;

FIG. 7 is a cross section illustrating the third embodiment; and

FIG. 8 is a side view illustrating a modification of the present invention.

### DETAILED DESCRIPTION

### First Embodiment

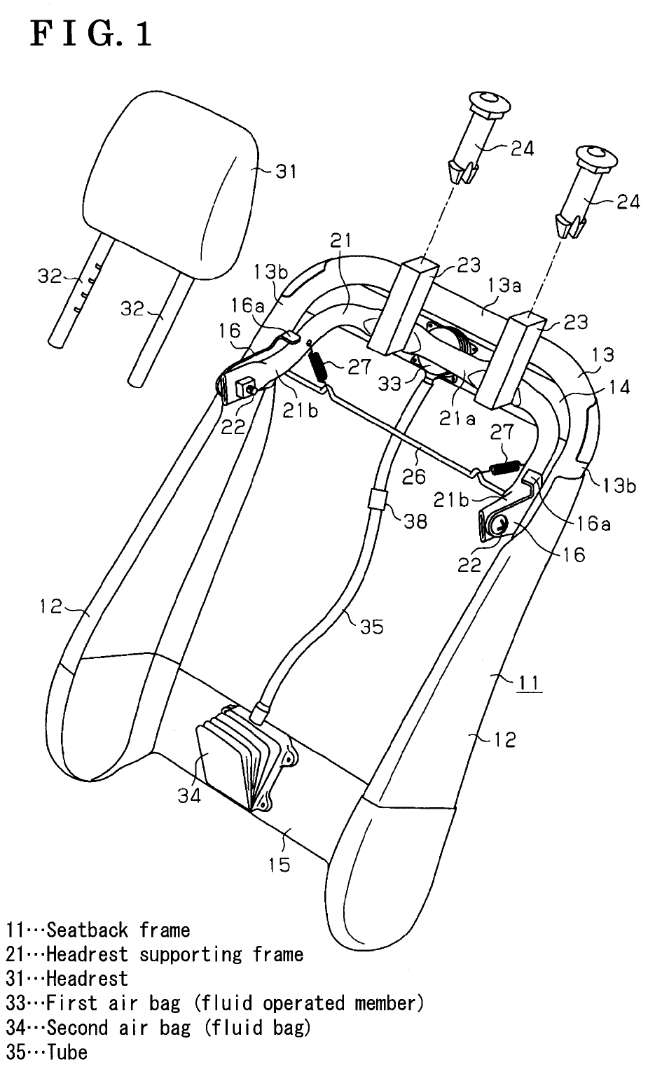

A first embodiment which embodies the present invention will be described below with reference to drawings. FIG. 1 is a perspective view illustrating a frame of a seat provided with a headrest moving device for a vehicle according to the first embodiment. As illustrated in FIG. 1, the seat provided with a headrest moving device for a vehicle is provided with a seatback frame 11 which structures a frame of the seatback. The seatback frame 11 includes a pair of side frames 12 which are made of a plate material and an upper pipe 13 which is made of a pipe material. The side frames 12 are arranged to face each other in a width direction of the vehicle (crosswise direction relative to a front side of the vehicle), and the upper pipe 13 connects the side frames 12 at an upper end portion of each side frame 12.

The upper pipe 13 is bent so as to form a U shape and has a main portion 13a and a pair of arms 13b. The main portion 13a extends in the width direction of the vehicle and the pair of arms 13b extends downward continuously from each end portion of the main portion 13a. An upper frame 14, which is made of a plate extending in the width direction of the vehicle, connects the arms 13b at an upper end portion of each arm 13b. Also, a lower frame 15, which is made of a plate material extending in the width direction of the vehicle, connects the side frames 12 at a lower end portion of each side frame 12.

A hinge bracket for the seatback frame 16, which is made of a plate material extending to the front side of the vehicle, is jointed to a lower end portion of each arm 13b and a headrest supporting frame 21, which is made of a pipe material, is movably (pivotably) supported by the hinge brackets for the seatback frame 16. More specifically, the headrest supporting frame 21 is bent so as to form a U shape and has a main portion 21a and a pair of lever portions 21b. The main portion 21a extends in the width direction of the vehicle and the pair of the lever portion 21b extends downward continuously from each end portion of the main portion 21a. The headrest supporting frame 21 is pivotably supported by the hinge brackets for the seatback frame 16 at a lower end portion of each lever portion 21b by way of a hinge pin 22.

A pivot stopper 16a is integrally formed at each hinge bracket for the seatback frame 16 for restricting a pivotal movement range of the headrest supporting frame 21 in one direction (counter clockwise direction viewed in FIG. 1). Each pivot stopper 16a extends inward relative to the width direction of the vehicle so as to intercept a pivotal trajectory of each lever portion 21b.

A pair of support brackets 23 is jointed with the main portion 21a of the headrest supporting form 21 so as to be symmetric relative to the width direction of the vehicle. Each support bracket 23 is formed in a square tubular shape and the axial line of the supporting bracket 23 extends in a vertical direction. A headrest stay sliding support 24, which is made of resin, is fitted into each supporting bracket 23, and a pair of stays 32 of a headrest 31 is inserted into the pair of headrest stay sliding supports 24. Namely, the headrest 31 is supported by the support brackets 23 of the headrest supporting frame 21 in a detachable manner by inserting each stay 32 into the corresponding headrest stay sliding support 24.

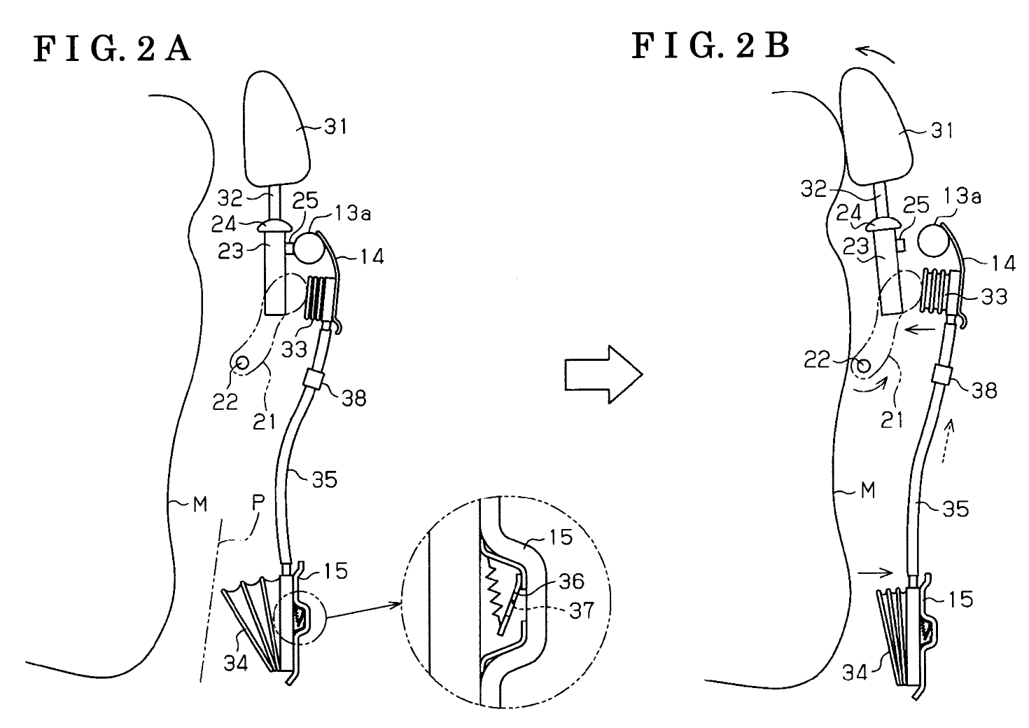

The axial length of each support bracket 23 is set so as to extend upwardly beyond the main portion 13a (refer to FIG. 2). A cushion rubber 25 is jointed to each support bracket 23 and the cushion rubber 25 elastically contacts with the main portion 13a in response to the pivotal movement of the headrest supporting frame 21 in the other direction (clockwise direction viewed in FIG. 2) to restrict the pivotal movement range in the direction.

A wire 26 extends in the width direction of the vehicle, and tip portions of the wire 26 are respectively secured at the lower end portion of each arm 13b of the upper pipe 13, which is in the vicinity of the hinge bracket for the seatback frame 16. One end of each tension spring 27 is engaged with the corresponding lever portion 21b and the other end of each tension spring 27 is engaged with the wire 26. Thus, the headrest supporting frame 21 is biased in a direction that each cushion rubber 25 jointed with the support bracket 23 comes in contact with the main portion 13a with the binge pin 22 serving as a center of the contact movement.

A bellows-like first air bag 33 (operational fluid bag) serving as a fluid operated member is fixed to a center portion of the upper frame 14 in a manner that the first air bag 33 is sandwiched between the upper frame 14 and the main portion 21a of the headrest supporting frame 21. The first air bag 33 may extend in a direction perpendicular to the upper frame 14 (longitudinal direction of the vehicle) by air, which serves as a fluid, flowing into or flowing out from the inside of the first air bag 33.

On the other hand, a second air bag 34, which serves as a fluid bag, is fixed to a central portion of the lower frame 15 extending toward the front side of the vehicle. The second air bag 34 is formed in a bellows-like shape by blow molding. The second air bag 34 may extend in the longitudinal direction of the vehicle by air flowing into or flowing out from the inside of the second air bag 34 and forms a fan-like shape when extended. The second air bag 34 is connected with and is in communication with the first air bag 33 through a tube 35. Thus, the internal air of the second air bag 34 is movable to the first air bag 33 through the tube 35.

As illustrated in the enlarged view of FIG. 2A, an intake valve 36 is provided at the second air bag 34 to take air into the inside of the second air bag 34, and a natural shape of the second air bag 34, which is observed under a condition that no load is applied in a compressing direction, is inflated by taking in air through the intake valve 36. Thus, the second air bag 34 basically maintains a state of contacting to or being adjacent to a backside of a pad P in the seatback.

The intake valve 36 has a discharging function used for discharging the internal air when an internal pressure of the second air bag 34 is low and is closed when the internal pressure reaches a first predetermined value or more. Accordingly, when the second air bag 34 is compressed slowly by the action of an occupant M such as pressing its back or knee at the seatback, the internal air is discharged through the intake valve 36. Thus, the discharge of air allows the second air bag 34 to deflate while restraining air from flowing into the first air bag 33 through the tube 35. On the other hand, when an upper body of the occupant M is moved rearward at a time of a rear-end vehicle collision to compress the second air bag 34 rapidly, the internal pressure reaches the first predetermined value or more. Then, the intake valve 36 is closed and the closure allows air to flow into the first air bag 33 through the tube 35.

Further, an orifice 37, which serves as a discharging means, is formed in the intake valve 36 and penetrates a central portion of the intake valve 36. The orifice 37 is used for discharging the internal air when the internal pressure of the second air bag 34 reaches a second predetermined value, which is sufficiently larger than the first predetermined value, or more. The second predetermined value is set so as to be smaller than allowable internal pressures of the first and second air bags 33 and 34, where the first and second air bags 33 and 34 are unlikely to burst. The internal pressure of the second air bag 34 may reach the second predetermined value or more because an extra air capacity is provided to the second air bag 34 in order to avoid malfunction of the first air bag 33 due to reduction in atmospheric pressure. In other words, an excessive amount of air is stored in the second air bag 34 at low altitudes, and thus the internal pressure of the second air bag 34 may reach the second predetermined value or more.

Furthermore, a check valve 38 is provided at the tube 35. The check valve 38 prevents air from flowing from the first air bag 33 to the second air bag 34 when the internal pressure of the first air bag 33 reaches a predetermined value or more.

Next, the operation of the embodiment will be described with reference to FIGS. 2A and 2B. FIG. 2A illustrates a state that the second air bag 34 inflates without receiving the load applied in the compressing direction, and FIG. 2B illustrates a state that the second air bag 34 is compressed rapidly when the upper body of the occupant M is moved rearward at the time of the rear-end vehicle collision.

As illustrated in FIGS. 2A and 2B, when the upper body of the occupant M is moved rearward at the time of the rear-end vehicle collision and the second air bag 34 is compressed, the internal pressure of the second air bag 34 reaches the first predetermined value or more. Then, the intake valve 36 is closed and air flows into the first air bag 33 through the tube 35. Thus, the first air bag 33 inflates and presses the main portion 21a of the headrest supporting frame 21 against the tension springs 27. Consequently, the headrest supporting frame 21 pivots in one direction about the hinge pins 22 (counter clockwise direction viewed in FIGS. 2A and 2B) and the headrest 31 moves forward and thereby approaching a head of the occupant M to support the head from behind.

At the time, if the head of the occupant M collides with the headrest 31 and the internal pressure of the first air bag 33 reaches the predetermined value or more, the check valve 38 prevents air from flowing from the first air bag 33 to the second air bag 34. Thus, the first air bag 33 maintains the internal air and ensures to maintain the inflation thereof. Accordingly, the head is supported by the headrest 31 in a suitable way. After the rear-end vehicle collision is over, the head of the occupant M draws away from the headrest 31. Consequently, the internal pressure of the first air bag 33 falls below the predetermined value, and thus the first air bag 33 is brought back to an original state.

Also, in the case that the internal pressure of the second air bag 34 increases more than expected due to a severe rear-end vehicle collision, when the internal pressure reaches the second predetermined value or more, the internal air of the second air bag 34 is discharged by the orifice 37. Thus, the burst of the second air bag 34 is prevented.

On the other hand, when the second air bag 34 is compressed slowly by the action of the occupant M such as pressing its back or knee at the seatback, the internal air is discharged through the intake valve 36. The discharge of air allows the second air bag 34 to deflate while restraining air from flowing into the first air bag 33 through the tube 35. Thus, the malfunction of the headrest 31 is restrained.

As described above, according to the embodiment, the below-described effects are obtained.

(1) In the embodiment, the first air bag 33, which is related to the operation of the headrest 31, is disposed on the upper portion of the seatback frame 11 and is placed within the seatback. Thus, when the headrest 31 is inserted into the support brackets 23 (headrest stay sliding supports 24) of the headrest supporting frame 21, the first air bag 33 is not subject to any constraints. That is, at the vehicle assembly process, even when the seat provided with the headrest moving device for the vehicle excluding the headrest 31 is firstly mounted to the vehicle and then the headrest 31 is inserted thereinto, the headrest 31 is easily inserted to the support brackets 23 of the headrest supporting frame 21. Also, the headrest 31 is easily detached from the support brackets 23 of the headrest supporting frame 21.

Further, the operation of the headrest 31 is carried out based on the rearward movement of the upper body of the occupant M at the time of the rear-end vehicle collision and uses a force (pressing force) generated at the time of the rearward movement. Thus, it is not necessary to configure complicated systems such as the one, in which a rear-end collision detecting sensor is provided and the headrest 31 is driven by operating an appropriate actuator based on the detecting signals of the sensor. Therefore, the configuration of the seat is remarkably simplified.

Furthermore, the headrest 31 is easily brought back to the original state. For example, even when the headrest is operated by a mild rear-end vehicle collision, it is possible to repeatedly use the headrest 31 due to the configuration.

(2) In this embodiment, air is used as the fluid, which is related to the operation of the headrest 31. Thus, the response time of the headrest 31 is reduced, compared to the one using the liquid, for example.

(3) In this embodiment, when the second air bag 34 is compressed slowly by the action of the occupant M such as pressing its knee at the seatback, the internal air is discharged through the intake valve 36. Thus, the discharge of air restrains the fluid from flowing into the first air bag 33 through the tube 35 and restrains the malfunction of the headrest 31. When the upper body of the occupant M is moved rearward at the time of the rear-end vehicle collision, the second air bag 34 is compressed rapidly and the internal pressure reaches the first predetermined value or more. Then, the intake valve 36 is closed and the closure enables air to flow into the first air bag 33 through the tube 35 to allow the operation of the headrest 31.

(4) In this embodiment, even if the internal pressure of the second air bag 34 increases more than expected due to the severe rear-end vehicle collision, the internal air is discharged by the orifice 37 when the internal air of the air bag 34 reaches the second predetermined value or more. Thus, it is possible to prevent the second air bag 34 from bursting.

(5) In this embodiment, when the internal pressure of the first air bag 33 reaches the predetermined value or more, the check valve 38 prevents air from flowing from the first air bag 33 to the second air bag 34. Thus, when the headrest 31 contacts with the head of the occupant M, the air of the first air bag 33 is maintained and the head is supported by the headrest 31 in the suitable manner.

### Second Embodiment

A second embodiment which embodies the present invention will be described below with reference to drawings. A seat provided with a headrest moving device for a vehicle according to the second embodiment is provided with a wedge-shaped cam member engaged with the headrest supporting frame 21 and the like. Thus, identical reference numerals are given to the configurations which are identical to that of the first embodiment, and a part of the description will be omitted.

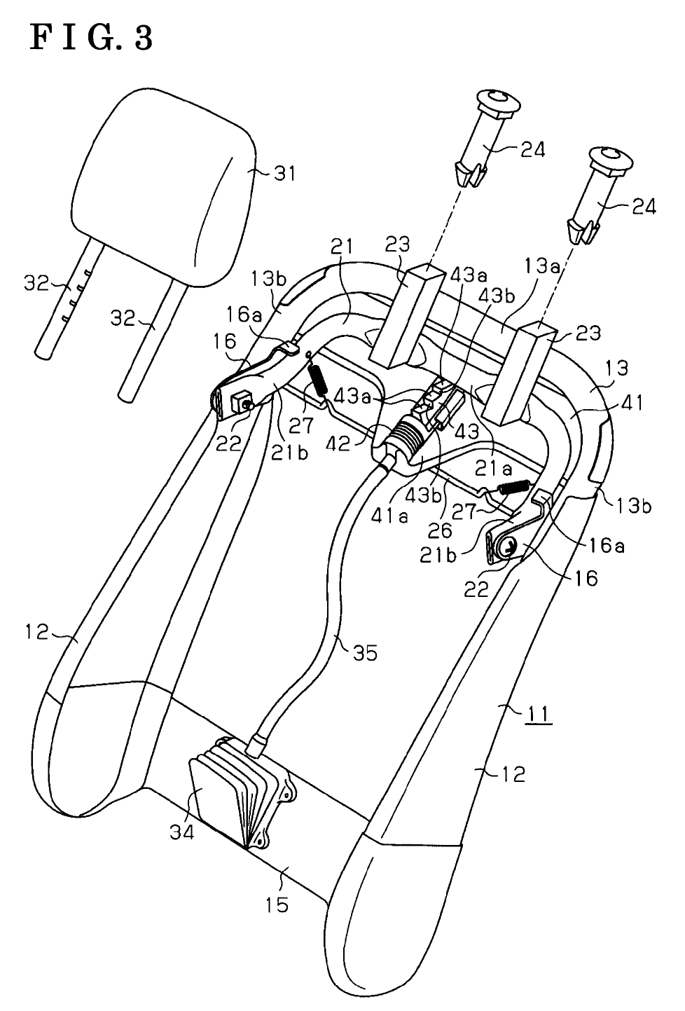

FIG. 3 is a perspective view illustrating a frame of the seat provided with the headrest moving device for a vehicle according to the second embodiment. As illustrated in FIG. 3, an upper frame 41 of the third embodiment is made of a plate material extending in the width direction of the vehicle and connects the arms 13b at the upper end portion of each arm 13b. Further, the upper frame 41 is formed with an extending portion 41a extending downwardly from a center portion of the upper frame 41, and a bellows-like first air bag 42 is fixed to the extending portion 41a to serve as a fluid operated member. The first air bag 42 may extend in the vertical direction along the upper frame 41 by air flowing into or flowing out from the inside thereof.

The wedge shaped cam member 43 contacts or joints with a tip end of the first air bag 42. The cam member 43 includes a plurality (four) of inclined surfaces 43a and steps 43b. Each inclined surface 43a is formed so that the length of the protruding portion protruded from the upper frame 41 reduces as proceeding upward along the upper frame 41, and each step 43b is disposed between the adjacent inclined surfaces 43a. Namely, when viewed as a whole, the cam member 43 presents a stepped shape which is tapered as proceeding upward along the upper frame 41.

The cam member 43 is supported so as to be movable along the upper frame 41 in the vertical direction in a manner that the cam member 43 is sandwiched between the main portion 21a of the headrest supporting frame 21 and the upper fame 41. Accordingly, the cam member 43 engages with the upper frame 41 and the headrest supporting frame 21 so as to increase a relative distance between the upper frame 41 and the main portion 21a of the headrest supporting frame 21 in response to an upward movement of the cam member 43 along the upper frame 41.

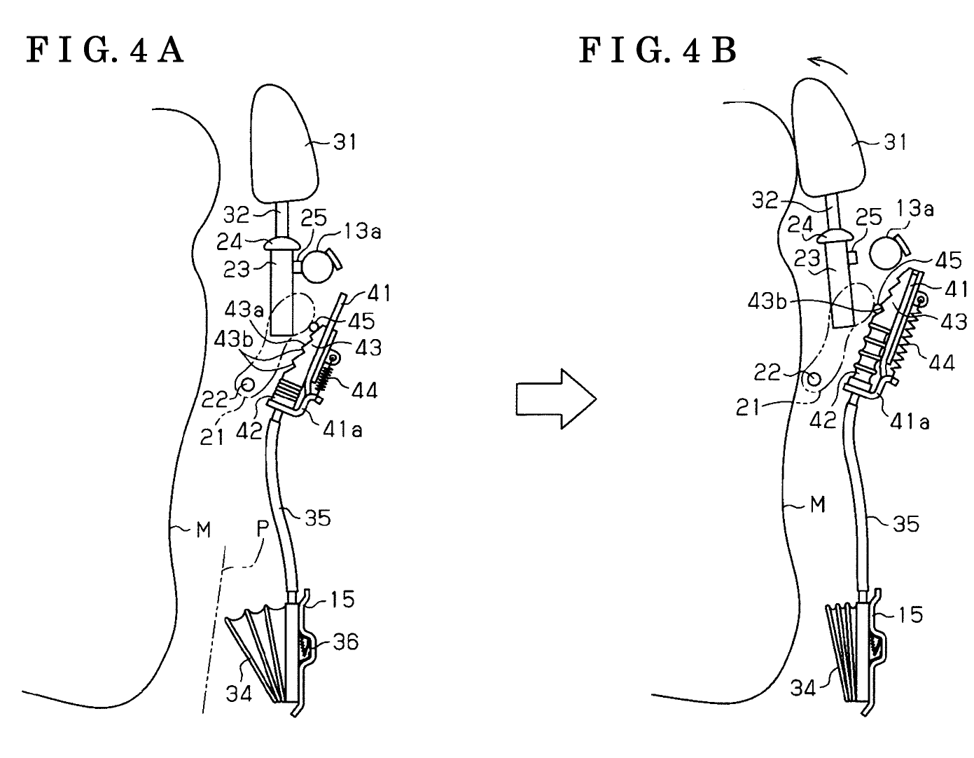

One end of a tension spring 44 is engaged with the extending portion 41a and the other end of the tension spring 44 is engaged with the cam member 43 (refer to FIG. 4). This configuration biases the cam member 43 along the upper frame 41 in a downward direction, i.e., a direction that the relative distance between the upper frame 41 and the main portion 21a of the headrest supporting frame 21 decreases.

As illustrated in FIG. 4, a protruding engaging piece 45 is fixed to the main portion 21a so as to face the cam member 43. When the cam member 43 moves upward along the upper frame 41, the engaging piece 45 slides the inclined surface 43a and is engaged with the step 43b. The engagement restricts the downward return movement of the cam member 43 along the upper frame 41. As just described, the engagement between the cam member 43 and the engaging piece 45, which restricts the return movement of the cam member 43, configures a ratchet mechanism.

In the embodiment, the headrest supporting frame 21 is biased by the tension springs 27 to a direction that the engaging piece 45 comes in contact with the cam member 43 with the hinge pins 22 serving a center of the contact movement. Thus, the cam member 43 engages with the engaging piece 45 more securely by way of the step 43b and slides the inclined surfaces 43a as moving upward along the upper frame 41. Consequently, the movement of the cam member 43 increases the relative distance between the upper frame 41 and the main portion 21a of the headrest supporting frame 21. The headrest 31 supported by the support brackets 23 (head rest stay sliding supports 24) of the headrest supporting frame 21 moves forward receiving restriction on the rearward return movement. In the embodiment, the engagement between the headrest supporting frame 21 (engaging piece 45) and the cam member 43 restricts the rearward return movement of the headrest 31 and thus the aforementioned check valve 38 provided at the tube 35 is left out.

The operation of the embodiment will be generally described with reference to FIGS. 4A and 4B. FIG. 4A illustrates a state that the second air bag 34 inflates without receiving the load applied in the compressing direction of the second air bag 34. FIG. 4B illustrates a state that the second air bag 34 is compressed rapidly when the upper body of the occupant M is moved rearward at the time of the rear-end vehicle collision.

As illustrated in FIGS. 4A and 4B, when the upper body of the occupant M is moved rearward at the time of the rear-end vehicle collision and the second air bag 34 is compressed, the internal pressure of the second air bag 34 reaches the first predetermined value or more. Then, the intake valve 36 is closed and air flows into the first air bag 42 through the tube 35. Thus, the first air bag 42 inflates and the cam member 43 moves upward along the upper frame 41 against the tension spring 44. Consequently, the cam member 43 presses the main portion 21a of the headrest supporting frame 21 against the tension spring 27, and the headrest supporting frame 21 pivots in one direction (counter clockwise direction viewed in FIGS. 4A and 4B) about the hinge pins 22. Then, the headrest 31 moves forward and thereby approaching the head of the occupant M to support the head from behind.

At the time, even if the head of the occupant M collides with the headrest 31 and an impact is applied to the cam member 43 and the like, the downward return movement of the cam member 43 along the upper frame 41 is still restricted because the cam member 43 engages with the engaging piece 45 by way of the step 43b. As a result, the rearward return movement of the headrest 31 is restricted. Therefore, the head is supported by the headrest 31 in the suitable manner. After the rear-end vehicle collision is over, the headrest 31 is drawn forward to release the engagement between the cam member 43 and the engaging piece 45 at the step 43b. Thus, the first air bag 42 is brought back to the original state gradually while being compressed.

As described above, according to the embodiment, the below-described effects are obtained in addition to the effects (1) to (4) described in the first embodiment.

(1) In this embodiment, the downward return movement of the cam member 43 along the upper frame 41 is restricted by engaging the cam member 43 with the engaging piece 45 by way of the step 43b, and thus the rearward return movement of the headrest 31 is restricted. Therefore, the head is supported by the headrest 31 in the suitable manner at the time of the rear-end vehicle collision.

(2) In this embodiment, the tension spring 44 is provided to bias the cam member 43 downwardly along the upper frame 41. Thus, the malfunction of the headrest 31, which is caused by an unintended upward movement of the cam member 43, is restrained.

### Third Embodiment

A third embodiment that embodies the present invention will be described below with reference to drawings. In the third embodiment, the structures of a headrest supporting frame, which support the headrest 31, and the like are varied. Thus, identical reference numerals are given to the configurations which are identical to the first embodiment and a part of the description will be omitted.

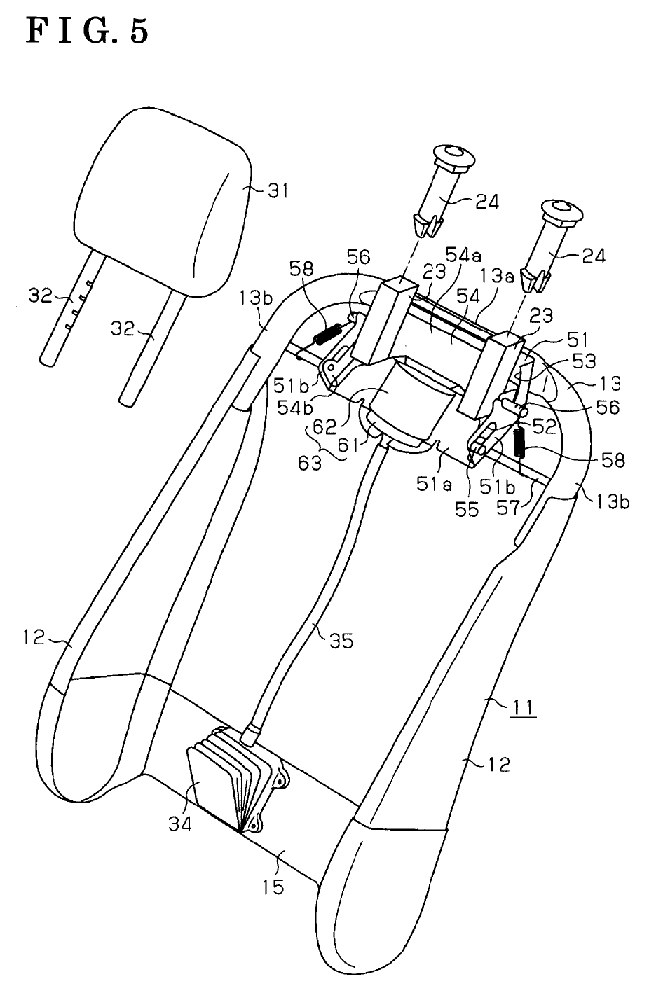

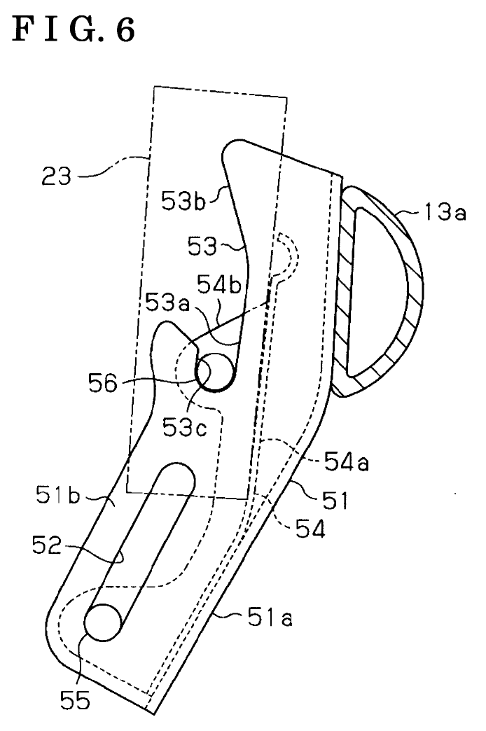

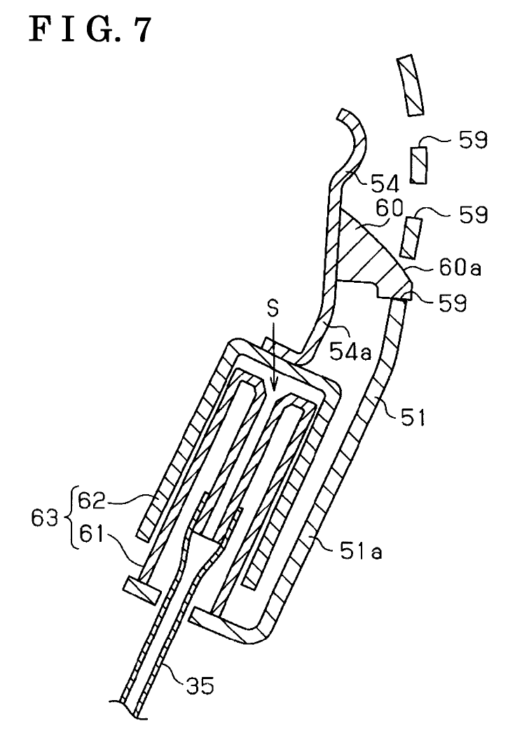

FIG. 5 is a perspective view illustrating a frame of a seat provided with a headrest moving device for a vehicle according to the third embodiment, and FIGS. 6 and 7 are cross sections thereof. As illustrated in FIG. 5, an upper frame 51 of the third embodiment is made of a plate material and includes a main portion 51a and a pair of supporting portions 51b. The main portion 51a stretches out in a flat plate shape and each supporting portion 51b is formed continuously from a width-directional end portion of the main portion 51a and bends forward. The upper frame 51 is jointed with the main portion 13a of the upper pipe 13 at an upper end portion of the main portion 51a.

As illustrated in FIG. 6, an elongated hole 52, which extends in the vertical direction, is formed at a lower end portion of each supporting portion 51b. The longitudinal shape of each elongated hole 52 inclines rearward relative to the vertical direction as proceeding upward thereof. Further, a rearward restricting surface 53, which serves as a guide portion extending in the vertical direction, is formed in an upper end portion of each supporting portion 51b. A lower end portion of the rearward restricting surface 53A forms a first restricting surface 53a, and the first restricting surface 53a inclines forward relative to a longitudinal direction of the elongated hole 52. Further, an upper end portion of the rearward restricting surface 53, which is continuously formed from the first restricting surface 53a, forms a second restricting surface 53b and the second restricting surface 53b inclines forward relative to the first restricting surface 53a.

A headrest supporting frame 54, which is made of a plate material, is movably supported by the upper frame 51. More specifically, the headrest supporting frame 54 includes a main portion 54a and a pair of supporting portions 54b. The main portion 54a has a narrower width than the upper frame 51 (main portion 51a) and stretches out in a flat plate shape. Each supporting portion 54b is formed continuously from a width directional end portion of the main portion 54a and bends forward. A pair of lower guide pins 55, each located at the supporting portion 54b corresponding to the elongated hole 52, is protruded and each guide pin 55 is inserted into the corresponding elongated hole 52 to support the headrest supporting frame 54. Also, a pair of upper guide pins 56, each located at the supporting portion 54b corresponding to the rearward restricting surface 53, is protruded and contacts with the rearward restricting surfaces 53 to position the headrest supporting frame 54. The pair of the support brackets 23 is jointed with the main portion 54a of the headrest supporting frame 54.

Accordingly, for example, when the lower guide pins 55 moves upwardly along the elongated holes 52, the upper guide pins 56 are guided by the rearward restricting surfaces 53. Consequently, the headrest supporting frame 54 moves so as to incline forward with the lower guide pins 55 serving as a center of the inclining movement. Then, the headrest 31, which is supported by the support brackets 23 of the headrest supporting frame 54 (headrest stay sliding supports 24), moves forward as well as upward.

As illustrated in FIG. 5, a wire 57 extends in the width direction of the vehicle, and each tip portion of the wire 57 is secured at the lower end portion of each arm 13b of the upper pipe 13. One end of each tension spring 58 is engaged with the upper guide pin 56 and the other end of the tension spring 58 is engaged with the wire 57. Thus, the headrest supporting frame 54 is biased to a direction that the upper end thereof pivots rearward about the lower guide pin 55, i.e. a direction that the upper guide pins 56 come in contact with the rearward restricting surfaces 53.

As illustrated in FIG. 7, a plurality of engaging holes 59 is formed in a central portion of the main portion 51a having a distance in the vertical direction, and an engaging piece 60 is fixed to the main portion 54a of the headrest supporting frame 54. The engaging piece 60 is arranged to face each engaging hole 59 to be inserted thereinto. The tension springs 58 bias the headrest supporting frame 54 to a direction that the engaging piece 60 is inserted into the engaging hole 59. For example, when the lower guide pins 55 move upward along the elongated holes 52, the headrest supporting frame 54 releases the engagement between the engaging piece 60 and the engaging hole 59 by a guidance of a curved surface 60a of the engaging piece 60 to move. On the other hand, the downward return movement of the headrest supporting frame 54 is restricted when the engaging piece 60 is inserted into the engaging hole 59. As just described, the engagement between the engaging piece 60 and the engaging hole 59, which restricts the return movement of the headrest supporting frame 54, configures a ratchet mechanism.

An internal cylinder 61, which is formed in a cylindrical shape and has an axis line in parallel with the elongated hole 52, is secured to a lower end portion of a center of the upper frame 51 and the center of the internal cylinder 61 is passed therethrough. On the other hand, an external cylinder 62 is secured to a lower end portion of a center of the headrest supporting frame 54 and the external cylinder 62 is arranged concentrically with the internal cylinder 61. The internal cylinder 61 is air-tightly inserted into the external cylinder 62 and the internal and external cylinders 61 and 62 configure a cylinder 63 serving as a fluid operated member. An internal space S of the cylinder 63 is in contact with or is in communication with the tube 35. The cylinder 63 may extend in a direction that is parallel to the elongated hole 52 by air flowing into or flowing out from the inside of the cylinder 63.

Next, the operation of the third embodiment will be generally described. When the upper body of the occupant M is moved rearward at the time of the rear-end vehicle collision and the second air bag 34 is compressed, the internal pressure of the second air bag 34 reaches the first predetermined value or more. Then, the intake valve 36 is closed and air flows into the cylinder 63 (internal space S) through the tube 35. Thus, the cylinder 63 extends to press the headrest supporting fame 54 against the tension springs 58. At the time, each lower guide pin 55 moves along the corresponding elongated hole 52 and each upper guide pin 56 moves along the corresponding rearward restricting surface 53. Consequently, the headrest 31 moves upward as well as forward, and thereby approaching the head of the occupant M to support the head from behind.

At the time, even if the bead of the occupant M collides with the headrest 31 and an impact is applied to the headrest supporting frame 54 and the like, the downward return movement of the headrest supporting frame 54 is still restricted because the engaging piece 60 engages with the engaging hole 59. Consequently, the rearward return movement of the headrest 31 is restricted. Thus, the head is supported by the headrest 31 in the suitable manner. In this embodiment, the rearward return movement of the headrest 31 is restricted by the engagement between the engaging hole 59 and the engaging piece 60 and thus the aforementioned check valve 38 provided in the tube 35 is left out.

After the rear-end vehicle collision is over, the headrest 31 is drawn forward in a manner that the headrest supporting frame 54 pivots forward about the lower guide pins 55. Consequently, the engagement between the engaging piece 60 and the engaging hole 59 is released. Then, the headrest 31 is brought back to the original state gradually while compressing the cylinder 63. The above-mentioned releasing operation is restricted by a guide 53c when the headrest supporting frame 54 (upper guide pins 56) is at an initial position (refer to FIG. 6). Each guide 53c is continuously formed from a distal end of the rearward restricting surface 53 and bends to form a hook shape.

As described above, according to the embodiment, the below-described effects are obtained in addition to effects (1) to (4) described in the first embodiment.

(1) In this embodiment, the lower guide pins 55 move along the elongated holes 52 and the upper guide pins 56 move along the rearward restricting surfaces 53. The movement of the headrest supporting frame 54, which defines the moving trajectory of the headrest 31, is guided by the movements of the lower and upper guide pins 55 and 56. As just described, the movement of the headrest supporting frame 54 is guided, and thus the moving amount of an upper component of the headrest 31, which moves in response to the forward movement of the headrest 31, is easily adjusted. In order to place the headrest 31 in a suitable position for supporting the head of the occupant M from behind, the moving amount of the upper components of the headrest 31 may be set to be larger.

(2) In this embodiment, the headrest supporting frame 54 is biased by the tension springs 58 in the direction that the upper guide pins 56 come in contact with the rearward restricting surfaces 53 and thus the headrest supporting frame 54 is positioned more accurately.

(3) In this embodiment, the engagement between the engaging hole 59 and the engaging piece 60 restricts the return movement of the headrest supporting frame 54. Further, the engaging hole 59 and the engaging piece 60 are engaged more firmly by assistance of the tension springs 58. Thus, the head is supported by the headrest 31 at the time of the rear-end vehicle collision in the suitable manner. On the other hand, the engagement between the engaging hole 59 and the engaging piece 60 is easily released by drawing the headrest 31 forward in a manner that the headrest supporting frame 54 pivots forward about the lower guide pins 55 against the tension springs 58. Thus, the headrest 31 is easily brought back to the original position after the rear-end vehicle collision is over,

The above-mentioned embodiments will be varied as follows.

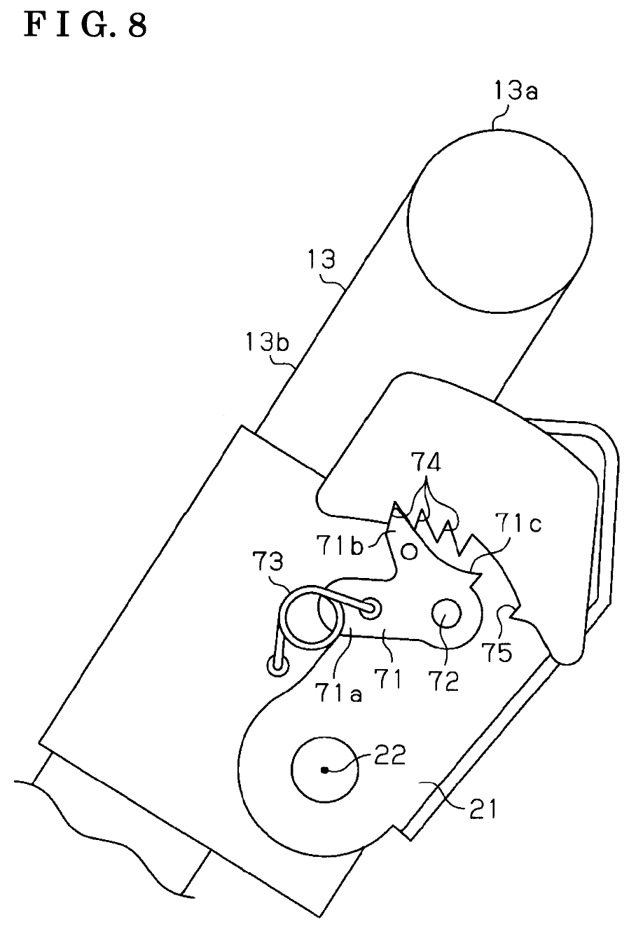

In the first embodiment, a ratchet mechanism may be provided for restricting the return movement of the headrest supporting frame 21. For example, as illustrated in FIG. 8, a ratchet mechanism having a turnover function may be provided in the vicinity of the hinge pin 22.

More specifically, a check lever 71 is coupled to the arm 13b of the upper pipe 13 via a bracket (not shown) so as to be pivotable about the hinge pin 72. The check lever 71 is formed in a V shape having a mounting piece 71a and an engaging pawl 71b. The mounting piece 71a extends in one direction and the engaging pawl 71b extends in the other direction that inclines toward the mounting piece 71a. One end of a torsion spring 73 is engaged with the arm 13b (bracket) and the other end of the torsion spring 73 is engaged with the mounting piece 71a. A protruding lever engaging piece 71c is formed in the vicinity of the hinge pin 72 of the check lever 71.

On the other hand, the headrest supporting frame 21 is formed with a plurality of engaging grooves 74 which may engage with the engaging pawl 71b. When the engaging pawl 71b engages with one of the engaging grooves 74, the check lever 71 is biased by the torsion spring 73 in a direction that the check lever 71 pivots in the counter clockwise direction about the hinge pin 72, i.e. a direction that assists the engagement between the engaging pawl 71b and the engaging groove 74. Further, the headrest supporting frame 21 is further formed with a protruding engaging piece 75 so as to face the lever engaging piece 71c.

In the configuration, for example, when the headrest supporting frame 21 pivots forward about the hinge pin 22, the headrest supporting frame 21 releases the engagement between the engaging pawl 71b and the engaging groove 74 by a guidance of the engaging groove 74 and pivots. On the other hand, when the engaging pawl 71b engages with the engaging groove 74, the return movement of the headrest supporting frame 21 is restricted.

Also, if the headrest supporting frame 21 pivots further forward about the hinge pin 22, the lever engaging piece 71c is pressed by the engaging piece 75 and thus the check lever 71 pivots in the counter clockwise direction about the hinge pin 72. At the time, the direction of the biasing force of the torsion spring 73 switches to the direction that pivots the check lever 71 in the counter clockwise direction about the hinge pin 72 (turnover). Thus, the engagement between the engaging groove 74 and the engaging pawl 71b is released by the turnover and the return pivotal movement of the headrest supporting frame 21 is allowed.

After the rear-end vehicle collision is over, the headrest 31 is drawn forward in a manner that pivots the headrest supporting frame 21 further forward to the turnover range about the hinge pin 22, and the engagement between the engaging groove 74 and the engaging pawl 71b is released. Thus, the first air bag 33 is compressed and the headrest 31 is brought back to the original state gradually. Of course, the return pivotal movement of the headrest supporting frame 21 is restricted by the engagement between the engaging pawl 71b and the engaging groove 74 and thus the rearward return movement of the headrest 31 is restricted at the time of the rear-end vehicle collision. Therefore, the head is supported by the headrest 31 in the suitable manner.

Any stopper may be provided for controlling the amount of the inflation of the first air bag 33 to prevent the turnover function from operating when the first air bag 33 inflates to its maximum.

In the first embodiment, the check valve 38 may be disposed at any position between the first air bag 33 and the second air bag 34. In the first embodiment, the first air bag 33 may be fixed at the side of the headrest supporting frame 21 (main portion 21a).

In the second embodiment, the first air bag 42 and the cam member 43 may be fixed at the side of the headrest supporting frame 21 (main portion 21a). In the first and second embodiments, the cylinder may be employed, instead of the first air bags 33 and 42.

In the third embodiment, the rearward restricting surface 53 may be formed to have a curvature so as to protrude further forward relative to the longitude direction of the elongated hole 52. Also, instead of the rearward restricting surfaces 53, elongated holes, which positions the headrest supporting frame 54 in a similar manner, may be employed.

In the third embodiment, instead of the cylinder 63, the air bag may be employed. In each embodiment, the second air bag 34 is provided at the lower portion (lower frame 15) of the seatback frame 11, however, the second air bag 34 may be provided at an intermediate portion of the seatback frame 11. Specifically, both side frames 12 are connected to each other at each intermediate position with any frame, which extends in the width direction of the vehicle, to provide the second air bag 34 therein.

Next, a technical idea obtained from the embodiments and modifications will be additionally described. According to the second embodiment, a biasing means, which biases the cam member in the other directions is provided in the seat provided with a headrest moving device for a vehicle. According to the technical idea, the cam member is biased in the other direction by way of the biasing means and thus the malfunction of the headrest, which is caused by the unintended movement of the cam member in one direction, is restrained.

According to the above-described embodiment, the fluid operated member is configured by the first air bags 33 and 42 fixed to one of an upper portion of the seatback frame 11 and the headrest supporting frame 21, the first air bag 33 is inflated by inflow of the fluid caused by the rearward movement of the upper body of the occupant M at the time of the rear-end vehicle collision so as to press the other of the upper portion of the seatback frame 11 and the headrest supporting frame 21, and the headrest supporting frame 21 moves so as to move the headrest 31 forward.

According to above-described the embodiment, the seat provided with a headrest moving device for a vehicle includes a wedge shaped cam member 43 disposed between the upper portion of the seatback frame 11 and the headrest supporting frame 21, the cam member 43 contacted or jointed with the first air bag 42 and engaging with the upper portion of the seatback frame 11 and the headrest supporting frame 21 so that a relative distance between the upper portion of the seatback frame 11 and the headrest supporting frame 21 increases in response to a movement of the cam member 43 in one direction, wherein the first air bag 33 is operated by inflow of the fluid caused by the rearward movement of the upper body of the occupant M at the time of the rear-end vehicle collision, the cam member 43 is moved in the one direction and the headrest supporting frame 21 moves so as to move the headrest 31 forward.

According to the above-mentioned structure of the present invention, the upper body of the occupant M is moved rearward at the time of the rear-end vehicle collision and the second air bag 34 is compressed. Consequently, the fluid flows into the first air bag 33 through the tube 35 to operate the first air bag 33, and the headrest supporting frame 21 moves forward to move the headrest 31 forward. Thus, the headrest 31 approaches the head of the occupant M to support the head from behind. In this case, the first air bag 31, which is related to the operation of the headrest 31, is disposed at the upper portion of the seatback frame 21 and is placed within the seatback. Accordingly, when the headrest 31 is inserted into the headrest supporting frame 21, the first air bag 31 is not subject to any constraints. Namely, even when the seat provided with a headrest moving device for a vehicle excluding the headrest 31 is mounted to the vehicle firstly and then the headrest 31 is mounted at the vehicle assembly process, the headrest 31 is easily inserted to the headrest supporting frame 21.

The operation of the headrest 31 uses the force dressing force) generated when the upper body of the occupant M is moved rearward at the time of the rear-end vehicle collision. Thus, it is not necessary to configure the complicated systems such as the one in which the rear-end collision detecting sensor is provided and the headrest 31 is driven by operating the appropriate actuator based on the detecting signal of the sensor. Therefore, the configuration of the seat is remarkably simplified.

According to the above-mentioned embodiment, the cylinder 63 is disposed between the upper portion of the seatback frame 11 and the headrest supporting frame 54, and the cylinder 63 includes a lower guide pin 55 provided at the headrest supporting frame 54, an upper guide pin 56 provided at the headrest supporting frame 54, an elongated hole 52 provided at the upper portion of the seatback frame 11 and supporting the headrest supporting frame 54 with the lower guide pin 55 inserted thereinto, a rearward restricting surfaces 53 provided at the upper portion of the seatback frame 11 and positioning the headrest supporting frame 54 with the upper guide pin 56 being contacted thereto, the cylinder 63 is operated by inflow of the fluid caused by the rearward movement of the upper body of the occupant M at the time of the rear-end vehicle collision, the lower guide pin 55 moves along the elongated hole 52 and the upper guide pin 56 moves along the rearward restricting surfaces 53, and the headrest supporting frame 54 moves so as to move the headrest 31 forward.

According to the above-mentioned structure, the lower guide pins 55 move along the elongated holes 52 and the upper guide pins 56 move the rearward restricting surfaces 53. The movement of the headrest supporting frame 54, which defines the moving trajectory of the headrest 31, is guided by the movements of the lower and upper guide pins 55 and 56. As just described, the movement of the headrest supporting frame 54 is guided, and thus it is possible to easily adjust the moving amount of the upper component of the headrest 31 in response to the forward movement of the headrest 31.

According to the above-described embodiments, the seats for the vehicle include ratchet mechanisms 43a, 43b, 45, 59, 60, 71 and 74 restricting a rearward return movement of the headrest supporting frame 21 and 54 supporting the headrest 31.

According to the above-mentioned structures, each ratchet mechanism 43a, 43b, 45, 59, 60, 71 and 74 restricts the return movement of the headrest supporting frame 21 and 54 and thus the headrest 31 supports the head at the time of the rear-end vehicle collision in the suitable manner.

According to the above-mentioned embodiments, the fluid is air.

According to the above-mentioned embodiments, the second air bag 34 is provided with an intake valve 36 closed when an internal pressure of the second air bag 34 reaches a first predetermined value or more.

According to the above-mentioned structure, air is used as the fluid, which is related to the operation of the headrest 31, and thus the response speed of the headrest 31 is improved.

According to the above-mentioned structure, when the second air bag 34 is compressed slowly by the action of the occupant's knee. The internal fluid (air) is discharged through the intake valve 36, and the discharge of the air restrains the air from flowing into the second air bag 34 through the tube 35, and the malfunction of the headrest 31 is restrained.

According to the above-mentioned embodiment, the second air bag 34 is provided with a discharge means 37 discharging an internal fluid thereof when the internal pressure of the second air bag 34 reaches a second predetermined value, which is larger than the first predetermined value, or more.

According to the above-mentioned structure, even when the internal pressure of the second air bag 34 increases more than expected by the severe vehicle collision and the like, the internal fluid (air) is discharged when the internal pressure of the fluid bag reaches the second predetermined value or more. Thus, the burst of the second air bag 34 is prevented.

According to the above-mentioned embodiment, a check valve 38 is provided between the second air bag 34 and the first air bag 33 to prevent a flow of the fluid from the first air bag 33 to the second air bag 34 when the internal pressure of the first air bag 33 reaches a predetermined value or more.

According to the above-mentioned structure, when the internal pressure of the first air bag 33, 42 reaches the predetermined value or more, the check valve 38 prevents the fluid (air) from flowing from the first air bag 33, 42 to the second air bag 34. Thus, when the headrest 31 contacts with the head of the occupant, the fluid (air) of the first air bag 34, 42 is retained. Therefore, the head is supported by the headrest 31 in the suitable manner.

The principles, of the preferred embodiments and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A headrest moving device for a vehicle comprising:
a headrest supporting frame adapted to be supported by a seatback frame and support a headrest so as to move forward;
a fluid operated member disposed at an upper portion of the seatback frame; and
a fluid bag provided at an intermediate portion or at a lower portion of the seatback frame, the fluid bag communicating with the fluid operated member through a tube.

2. A headrest moving device for a vehicle according to claim 1, wherein
the fluid operated member is configured by an operational fluid bag fixed to one of an upper portion of the seatback frame and the headrest supporting frame, the operational fluid bag is inflated by inflow of the fluid caused by the rearward movement of the upper body of the occupant at the time of the rear-end vehicle collision so as to press the other of the upper portion of the seatback frame and the headrest supporting frame.

3. A headrest moving device for a vehicle according to claim 1, further comprising:
a wedge shaped cam member disposed between the upper portion of the seatback frame and the headrest supporting frame, the cam member contacted or jointed with the fluid operated member and engaging with the upper portion of the seatback frame and the headrest supporting frame so that a relative distance between the upper portion of the seatback frame and the headrest supporting frame increases in response to a movement of the cam member in one direction when the fluid operated member is operated by inflow of the fluid caused by the rearward movement of the upper body of the occupant at the time of the rear-end vehicle collision.

4. A headrest moving device for a vehicle according to claim 1, wherein
the fluid operated member is disposed between the upper portion of the seatback frame and the headrest supporting frame, and wherein
the fluid operated member including:
a lower guide pin provided at the headrest supporting frame;
an upper guide pin provided at the headrest supporting frame;
an elongated hole provided at the upper portion of the seatback frame and supporting the headrest supporting frame with the lower guide pin movably inserted thereinto when the fluid operated member is operated by inflow of the fluid caused by the rearward movement of the upper body of the occupant at the time of the rear-end vehicle collision; and
a guide portion provided at the upper portion of the seatback frame and positioning the headrest supporting frame with the upper guide pin being contacted thereto.

5. A headrest moving device for a vehicle according to claim 3 further comprising:
a ratchet mechanism restricting a rearward return movement of the headrest supporting frame supporting the headrest.

6. A headrest moving device for a vehicle according to claim 4 further comprising:
a ratchet mechanism restricting a rearward return movement of the headrest supporting frame supporting the headrest.

7. A headrest moving device for a vehicle according to claim 5, wherein
the fluid is air.

8. A headrest moving device for a vehicle according to claim 6, wherein
the fluid is air.

9. A headrest moving device for a vehicle according to claim 7, wherein
the fluid bag is provided with an intake valve closed when an internal pressure of the fluid bag reaches a first predetermined value or more.

10. A headrest moving device for a vehicle according to claim 8, wherein
the fluid bag is provided with an intake valve closed when an internal pressure of the fluid bag reaches a first predetermined value or more.

11. A headrest moving device for a vehicle according to claim 9, wherein
the fluid bag is provided with a discharge means discharging an internal fluid thereof when the internal pressure of the fluid bag reaches a second predetermined value, which is larger than the first predetermined value, or more.

12. A headrest moving device for a vehicle according to claim 10, wherein
the fluid bag is provided with a discharge means discharging an internal fluid thereof when the internal pressure of the fluid bag reaches a second predetermined value, which is larger than the first predetermined value, or more.

13. A headrest moving device for a vehicle according to claim 9, wherein
a check valve is provided between the fluid bag and the fluid operated member to prevent a flow of the fluid from the fluid operated member to the fluid bag when the internal pressure of the fluid operated member reaches a predetermined value or more.

14. A headrest moving device for a vehicle according to claim 10, wherein
a check valve is provided between the fluid bag and the fluid operated member to prevent a flow of the fluid from the fluid operated member to the fluid bag when the internal pressure of the fluid operated member reaches a predetermined value or more.

15. A headrest moving device for a vehicle according to claim 11, wherein
a check valve is provided between the fluid bag and the fluid operated member to prevent a flow of the fluid from the fluid operated member to the fluid bag when the internal pressure of the fluid operated member reaches a predetermined value or more.

16. A headrest moving device for a vehicle according to claim 12, wherein
a check valve is provided between the fluid bag and the fluid operated member to prevent a flow of the fluid from the fluid operated member to the fluid bag when the internal pressure of the fluid operated member reaches a predetermined value or more.
